(19) United States
(12) Patent Application Publication
(10) Pub. No.: US 2008/0061143 A1
(43) Pub. Date: Mar. 13, 2008

(54) Merchandise Scanning Register

(75) Inventors: Reinhard Plaschka, Windach (DE); Alfred Schmidt, Munchen (DE); Martin Thorbjornson, Otterfing (DE)

Correspondence Address: BACON & THOMAS, PLLC, 625 SLATERS LANE, FOURTH FLOOR, ALEXANDRIA, VA, 22314, US

(73) Assignee: GIESECKE & DEVRIENT GMBH, Munich (DE)

(21) Appl. No.: 11/663,339

(22) PCT Filed: Sep. 19, 2005
(86) PCT No.: PCT/EP05/10084

§ 371 Date: Nov. 14, 2007

(30) Foreign Application Priority Data
Sep. 21, 2004 (DE) 10 2004 045 708.5

(51) Int. Cl. G06K 7/10

(52) U.S. Cl. 235/462.01

(57) ABSTRACT

In order to enhance the security of cash payment in trade, a merchandise scanning cash register with a two-channel scanner is suggested. The first channel operating at a first wavelength in the visible spectral range serves both for detecting bar-code information (5) provided on the merchandise (4) and for detecting a value coding (7) of a banknote (6) submitted by way of payment for the merchandise. The second channel of the scanner (2) serves for verifying the authenticity of the banknote (6) and operates in the IR range.

The invention relates to a method for the improvement of the security of cash payments in trade and in this context a merchandise scanning cash register.

Merchandise scanning cash registers are used in trade in order to read information-conveying codes provided on the merchandise, on the basis of which among other things a purchasing price is allocated to the merchandise in the cash register. The scanners connected to the cash register are mostly area laser scanners or bar-code laser scanners, which as a rule operate with visible red light.

In DE 101 07 344 A1 it is suggested to introduce such scanning cash registers in a method for the monitoring of the national and international cash circulation. For this purpose all banknotes are equipped with an identification bar code which is different for every banknote and which is inalterable, which identification bar code is read by means of the laser scanner of the cash register when payment for merchandise is effected. In addition to the serial number of the banknote, the code contains further data concerning the currency, denomination, date of issue, etc., as well as a check digit for checking reading errors. Upon each change of ownership the read-out coding is compared to a data set belonging to the coding which is stored in a central database. In this way, an emergence of stolen banknotes can be detected immediately on a worldwide scale. As an ancillary effect it is achieved that also the counterfeiting of banknotes becomes useless, for forgeries are recognized at once, since the detected coding either already exists in duplicate, or since the coding is not recognized. Since the coding also contains the value of the banknote, it is achieved as a further ancillary effect that the banknote of the customer and the change can be credited or debited automatically in the cash register.

It cannot be predicted whether such a central monitoring system can be realized in the foreseeable future, since all circulating banknotes have to be equipped with a corresponding coding for this purpose. In addition, it is rather simple to imitate a corresponding coding by copying or other types of printing processes and thus to produce such forgeries which are not recognized by the scanner. What is more, the recognition of duplicates requires a considerable effort concerning online network connections with a continuous synchronization of very large amounts of data.

It is therefore the object of the present invention to suggest a simple method for enhancing the security of cash payment in trade as well as non-complex technical means for carrying out the method, which can also be used for already existing banknote designs without bar codes.

This problem is solved by a method and a merchandise scanning cash register having the features of the independent claims. In claims dependent on these are specified advantageous developments and embodiments of the invention.

It is accordingly provided to scan the banknotes submitted by way of payment of the merchandise by means of two different wavelengths. For this purpose, the scanner connected to the cash register has two measuring channels.

The first measuring channel, with which also the merchandise information provided on the merchandise, thus in particular bar codes, is read, preferably simultaneously serves for recognizing the value of the banknotes submitted by way of payment of the merchandise. Therein preferably laser light in the visible red spectral range is used and the laser radiation reflected by the banknote is detected and evaluated.

For this purpose the laser beam is for example deflected by rotating mirrors and tilting mirrors such that it covers a greatest possible surface under different angles, and thus a high probability of the detection of codings or other typical signal patterns of the banknotes is given.

The value of the banknote results from a value coding, which is in the simplest case formed by the motif print which is visible to the observer and unambiguous with regard to the denomination of the banknote, since due to the motif print a characteristic local reflection pattern appears during the scanning with a defined path of the scanning beams. Instead of the motif print or in addition thereto, the value of a banknote can also be determined on the basis of a separate coding, e. g. a separate bar code.

It results that in order to detect the value of the banknote it is not necessary to adapt the scanner concerning the first measuring channel. Merely the evaluation device of the merchandise scanning cash register has to be upgraded for the identification of the banknote value.

The second measuring channel is however added in the conventional merchandise scanning cash registers. It operates e. g. in the IR range and primarily serves for examining the banknotes for authenticity. The reason is that for protection against forgery most banknotes also contain an authenticity feature which can be verified by means of IR irradiation, this means a feature which is not conspicuous e. g. under daylight irradiation, but which clearly differs with regard to the reflection properties and/or absorption properties in the first and second measuring channel. Complementing the addition of the second measuring channel, also the evaluation device should be upgraded, in order to be able to correspondingly evaluate the authenticity feature detected by means of the second measuring channel.

Preferably for this second measuring channel the same mirror system for the deflection of the second measuring channel's illuminating beam should be used as for the first measuring channel, so that the signals of the two measuring channels are unequivocally allocated to each other and can be evaluated together. The thus verified authenticity feature of the banknotes cannot be forged by means of simple methods, on no account through simple copying.

Thus by the simple upgrading of existing merchandise scanning cash registers with a two-channel scanner and an extension of the evaluation software, a merchandise scanning cash register can be realized, with which in addition to the bar codes provided on the merchandise also the banknotes for payment of the merchandise can be detected with regard to their value and can be simultaneously checked for authenticity. When a valid banknote is recognized, the merchandise scanning cash register produces a signal, e. g. acoustically, and the value is automatically transmitted to the cash register. Thereby also the necessity to enter the value of the banknotes into the cash register by hand is eliminated, and the protection against forgery is in addition improved considerably. It is ensured that no forgeries are accepted and that no forgeries are handed out any more as change.

The method and the correspondingly adapted merchandise scanning cash registers are in particular suitable to verify the authenticity of banknotes which have an IR split in the motif print, i. e. have IR-absorbing sections and IR-reflecting sections in the motif print. The forgery-proofness can be additionally enhanced through a comparison of the position of these IR-absorbing sections and IR-reflecting sections relative to the position of the value coding, thus of the motif print itself, detected by means of the first measuring channel. Furthermore, due to the narrow tolerances the laser offers a very high accuracy with regard to the spectral evaluation of the reflected signals, e. g. by an evaluation of absolute or relative reflection values of the two measuring channels. The IR authenticity feature can form a bar code within the motif print. However, it can also be a code which is completely independent from the motif print, and which possibly has a fixed local relation to the print.

In the following, the invention is explained by way of example with reference to the accompanying figures. The figures are described as follows:

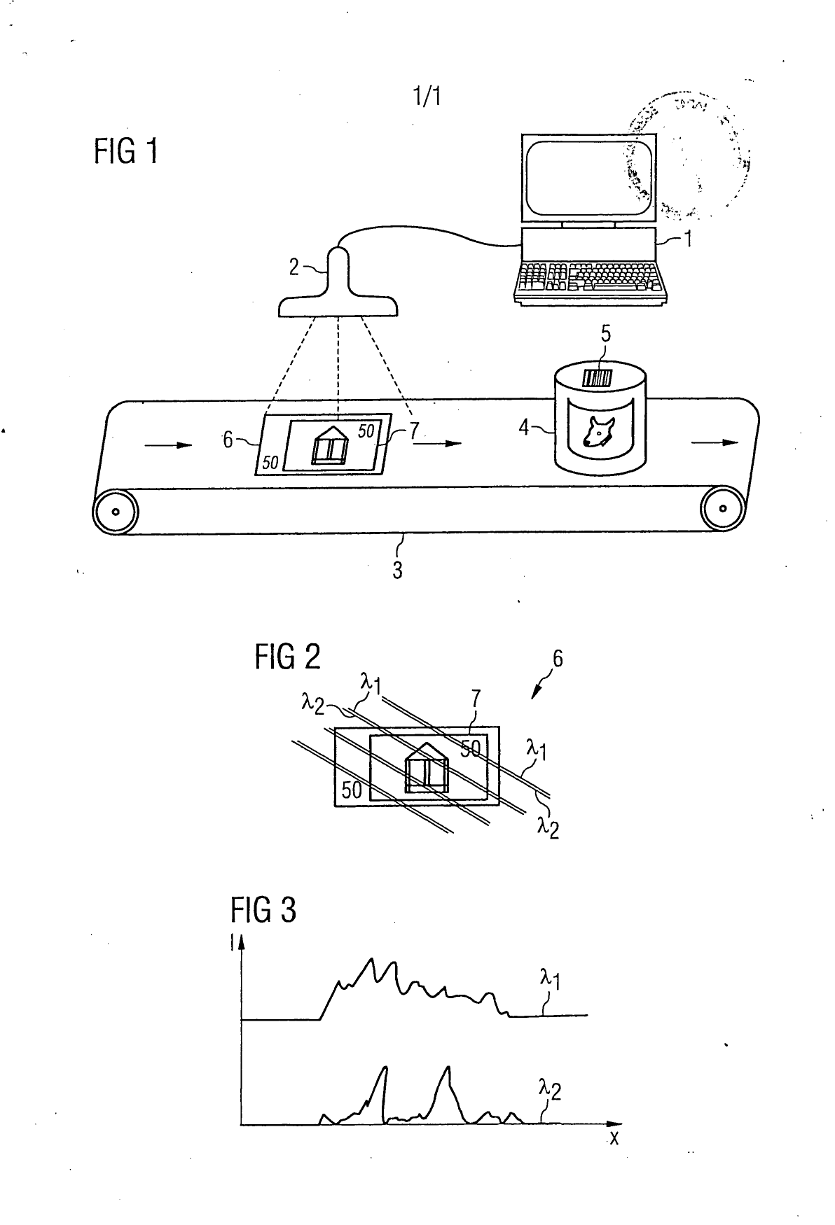

FIG. 1 a merchandise scanning cash register with digital cash register and connected scanner,

FIG. 2 a banknote in a top view with superimposed scanning lines, and

FIG. 3 the chronological order of the remission intensities at two wavelengths λ₁ und λ₂ detected during scanning.

FIG. 1 schematically shows a merchandise scanning cash register comprising a digital cash register 1 with a monitor screen and a keyboard as well as a scanner 2 connected thereto. On a conveyor belt 3 firstly products 4 are carried past the merchandise scanning cash register. Information-conveying bar codes 5 provided on the products 4 are read by means of the scanner 2 and transmitted to the digital cash register 1. On the basis of this merchandise information a purchasing price total is calculated by the cash register and is for example output by displaying it on the monitor screen of the cash register 1. Subsequently a banknote 6 submitted by way of payment of the merchandise is scanned with the same scanner 2, on the one hand to detect a value coding of the bank note, and on the other hand to detect an authenticity feature of the banknote.

The scanner 2 in FIG. 1 is shown as a handheld scanner. Instead, also a flat-bed scanner integrated in the transport system in the usual manner or an omni-directional scanner immovably mounted next to the transport system, past which the banknote 6 and the merchandise 4 are directed, can be provided.

The scanning of the banknote 6 is explained in greater detail with reference to FIG. 2 in the following. The scanner 2 comprises two measuring channels for verifying the reflection properties of the banknote 6 at two wavelengths λ₁ and λ₂ which differ from each other. Whereas the one wavelength λ₁ lies in the visible spectral range, preferably in the visible red range, and serves for detecting both the merchandise information by means of the bar code 5 and the value coding of the banknote 6, the second wavelength λ₂ lies in the infrared range and serves for verifying authenticity by means of an IR split in the motif print 7 of the banknote 6. Accordingly, the scanner 2 is for example equipped with laser diodes which radiate in the respective wavelength ranges λ₁ and λ₂, and is equipped with exactly adjusted detectors which detect the remission radiation and λ₂ locally. The detectors for detecting the remission radiation λ₁ and λ₂ are adjusted herein to directly adjacent and preferably overlapping measuring locations or measuring tracks. With the remission measuring in the visible wavelength spectrum λ₁ the motif print 7 of the banknote 6 is detected and the nominal value of the banknote is derived from the characteristic local intensity pattern (FIG. 3). This is carried out in an evaluation device of the cash register in which current banknote parameters are stored for comparison to the respectively detected measuring values.

The motif print 7 of the banknote 6 furthermore has an IR split by way of authenticity feature, thus has IR-absorbing sections and/or IR-reflecting sections of a characteristic local distribution in the motif print 7. The remission measuring of the IR radiation λ₂ then results in a correspondingly characteristic local intensity pattern I_{λ1} (FIG. 3), on the basis of which the authenticity of the banknote 6 is verified in the evaluation device of the cash register 1 through comparison with the reference values stored there.

Through an evaluation of several subsequent scans of the banknote, which cover different areas of the banknote due to the movement of the rotating mirror and/or the adjustable mirror, the evaluation security can be improved with regard to both the secure recognition of real bank notes and the rejection of forged banknotes.

In addition, a comparison of position of the local intensity patterns I_{λ1} (x), I_{λ2} (x) can be carried out, in order to additionally enhance the forgery-proofness. An additional comparison of position is primarily useful in the event that the verified IR authenticity feature is not an IR split in the motif print, but e. g. a simple IR bar code independent from the motif print, in which IR bar code the local intensity pattern of the remission radiation essentially only varies between a maximum value and a minimum value.

The evaluation of the banknote is particularly easy when it is recorded in a certain defined position to the scanner. In particular in the case of an integrated flat-bed scanner or an omni-directional scanner this can for example be realized in that the banknote is placed in a certain area of the scanner window. In the case of a handheld scanner this can for example be carried out by scanning the banknote from a certain distance lengthwise through the center of the banknote. In these cases the signals can be reproduced very well and can be evaluated and analyzed with little effort.

However, it is in principle also possible to securely evaluate the banknotes in any desired position relative to the scanning beams or to the scanner. As a rule, for this purpose the signals have to be examined for possible variations with regard to the angle and the size (or the distance) of the banknote relative to the scanner, and banknote-typical signals have to be extracted by means of suitable algorithms. It is advantageous herein if the edge of the banknote is not covered or delivers a defined pattern, so that the entry time and the exit time of a deflection beam can be found easily in the intensity patterns.

In principle, this method can also be applied when the banknote is held freely in space, wherein it does not necessarily have to be scanned by the scanner in a flat state. Preferably for this purpose the possible position of a banknote is firstly determined on the basis of the entry data and exit data and then the measured signal patterns are compared to the stored reference data for the same position.

As an extension of the method described above, it is also possible to reliably verify the state of wear of the banknotes, for instance to reliably recognize folded banknotes or such with damages (e. g. dog ears).

Instead of IR properties in principle also other spectral color properties of the banknote can be evaluated, e. g. in the far IR range or UV range, if required evaluating fluorescent, phosphorescent or other luminescent properties of the printing inks used.

Herein, for example the measurements are carried out at wavelengths which differ from the wavelength inducing the luminescence and at which luminescent radiation is present. In addition, in particular concerning phosphorescent properties of the banknote, also the time dependence, especially the decay time of the luminescent radiation, can be detected.

The method is furthermore not limited to laser beams, but can in principle also be implemented with other optical scanning systems. It is thereby rendered possible to freely choose the size of the scanning point or the scanning line on the banknote and to optimize the spectral evaluation to certain wavelength ranges. Generally also three or more different measuring channels, again preferably with different diode detectors and/or photo detectors, can be used, which irradiate the banknote at different wavelengths and/or detect the light emanating from the banknote at different wavelengths.

1. Merchandise scanning cash register comprising a digital cash register, a scanner connected to the cash register, with a first measuring channel operating at a first wavelength both for detecting information provided on merchandise and for detecting a value coding of banknotes submitted by way of payment of the merchandise, and an evaluation device for determining the value of the banknotes on the basis of the detected value coding, wherein the scanner comprises a second measuring channel operating at a second wavelength differing from the first wavelength for detecting an authenticity feature of the banknote.

2. Merchandise scanning cash register according to claim 1, wherein the second measuring channel is adapted for an IR measurement.

3. Merchandise scanning cash register according to claim 1, wherein the first measuring channel is adapted for a reflection measurement in the visual spectral range.

4. Merchandise scanning cash register according to claim 1, wherein the value coding is formed by a reflection pattern of a motif print of the banknote, which motif print is visible to an observer.

5. Merchandise scanning cash register according to claim 1, wherein the evaluation device is adapted to at least one of: compare the relative position of the value coding detected by means of the first measuring channel to the authenticity feature detected by means of the second measuring channel, and verify the state of the banknote.

6. Merchandise scanning cash register according to claim 5, wherein the authenticity feature is an IR split in a motif print of the banknote.

7. Merchandise scanning cash register according to claim 1, wherein the second measuring channel is adapted for a UV measurement.

8. Merchandise scanning cash register according to claim 1, wherein the evaluation device is arranged to verify the banknotes in at least one of a free position and a predetermined defined position, or the evaluation device is arranged to determine the position, of the banknote.

9. Merchandise scanning cash register according to claim 1, wherein the first or second measuring channel is adapted for a luminescence measurement and the evaluation device is arranged to determine whether the verified banknote shows a predetermined luminescent behavior.

10. Merchandise scanning cash register according to claim 1 wherein for at least one of: the irradiation of the banknote to be verified, and the detection of the radiation emanating from the irradiated banknote, the same optical components are used for the first measuring channel and the second measuring channel.

11. Method for enhancing the security of cash payment in trade, comprising the steps:
detecting merchandise information provided on merchandise by means of a scanner operating at a first wavelength,
transmitting the information to a digital cash register,
calculating and outputting a purchasing price total by the cash register on the basis of the merchandise information and
detecting a value coding of a banknote submitted by way of payment of the merchandise by means of the scanner operating at the same first wavelength,
including the further step of detecting an authenticity feature of the banknote by means of the same scanner, however at a second wavelength differing from the first wavelength.

12. Method according to claim 11, wherein the step of detecting the authenticity feature comprises irradiating the banknote with IR radiation and measuring the IR radiation reflected by the banknote.

13. Method according to claim 11, wherein the step of detecting the value coding comprises irradiating the banknote with radiation in the visual spectral range, and measuring the radiation reflected by the banknote in the visual spectral range.

14. Method according to claim 13, wherein the step of detecting the value coding comprises detecting a reflection pattern of a motif print of the banknote, which motif print is visible to an observer.

15. Method according to claim 11, including the further step of comparing a relative position of the value coding and the authenticity coding on the banknote.

16. Merchandise scanning cash register according to claim 1, wherein the evaluation device is arranged to verify the banknotes in at least one of a free position and a predetermined defined position and the evaluation device is arranged to determine the position of the banknote.

17. Merchandise scanning cash register according to claim 2, wherein the IR measurement comprises an IR reflection measurement.

18. Merchandise scanning cash register according to claim 3, wherein the spectral range is red light.
